(19) United States
(12) Patent Application Publication
(10) Pub. No.: US 2011/0227435 A1
(43) Pub. Date: Sep. 22, 2011

(54) MOTOR LOCK APPARATUS AND DRIVE APPARATUS FOR VEHICLE

(75) Inventor: Eiji Maeda, Fuji-shi (JP)

(73) Assignee: TOYOTA JIDOSHA KABUSHIKI KAISHA, Toyota-shi, Aichi-ken (JP)

(21) Appl. No.: 13/131,709

(22) PCT Filed: Dec. 15, 2008
(86) PCT No.: PCT/JP2008/072762

§ 371 Date: May 27, 2011

(51) Int. Cl. H02K 7/102

(52) U.S. Cl. 310/77

(57) ABSTRACT

A motor lock apparatus which can lock a rotor by a relatively simple structure and is advantageous to downsizing. The motor lock apparatus is applied to a motor generator having a stator and rotor which are installed so as to be rotatable relative to each other about a common axis, where the rotor has circumferentially arranged salient rotor poles projecting toward the stator. The motor lock apparatus has a lock plate and an actuator. The lock plate is fixed so as not to be rotatable about the axis and is movable between a locked position at which the lock plate is inserted between the salient rotor poles of the rotor and an unlock position at which the lock plate removed from between the salient rotor poles. The actuator drives the lock plate between the locked position and the unlocked position.

### TECHNICAL FIELD

The present invention relates to a motor lock apparatus which is applied to a motor having a plurality of salient portions arranged at a rotor aligning in the circumferential direction and a drive apparatus for a vehicle having the motor.

### BACKGROUND ART

There is known a reluctance motor to rotate a rotor by arranging a plurality of excitation portions at a stator at equal intervals in a circumferential direction and a plurality of salient portions projecting toward the stator at the rotor in a circumferential direction at equal intervals and exciting the respective excitation portions of the stator in predetermined order. There is known the above-mentioned reluctance motor in which the rotor is locked so as not to rotate during stoppage. For example, there is known a reluctance motor in which a rotor is arranged movably in an axis line direction and a compression spring is arranged to urge the rotor to one side along the axis line so as to rotationally lock the rotor by contacting a brake shoe disposed at the rotor and a friction member disposed at a housing as the compression spring moves the rotor to the one side at the time of stoppage (see Patent Document 1). In addition, Patent Document 2 is another prior art document related to the present invention.

### CITATION LIST

### Patent Literature

Patent Document 1: JP-A-10-210708
Patent Document 2: JP-A-9-156387

### SUMMARY OF INVENTION

### Technical Problem

In the apparatus of Patent Document 1, it is required that the brake shoe is disposed at a side of the rotor and the friction member is disposed at the housing as being opposed to the brake shoe. Therefore, there is fear that the apparatus is upsized as being prolonged in the axis line direction. Further, the rotor is required to be arranged as being movable in the axis line direction for performing contacting and separating between the brake shoe and the friction member. Therefore, there is fear that the apparatus becomes complicated.

In view of the foregoing, one object of the present invention is to provide a motor lock apparatus which can lock a rotor with a relatively simple structure and is advantageous to downsizing and a drive apparatus for a vehicle.

### Solution to Problem

A motor lock apparatus of the present invention is applied to a motor which includes a pair of rotating bodies arranged to be relatively rotatable about a common axis line, either one of the pair of rotating bodies functioning as a stator and the other one functioning as a rotor in which a plurality of salient portions projecting toward the rotating body to be the stator are aligned in the circumferential direction, and the motor lock apparatus includes: a lock member fixed as being non-rotatable about the axis line and being movable between a locked position to be inserted between the salient portions of the rotating body to be the rotor and an unlocked position to be removed from between the salient portions of the rotating body to be the rotor; and a drive device to drive the lock member between the locked position and the unlocked position.

According to the motor lock apparatus of the present invention, the rotating body to be the rotor can be locked with the lock member by moving the lock member to the locked position. In this case, since the rotating body can be locked by utilizing the plurality of salient portions arranged at the rotating body to be the rotor, it is not required to dispose a member to be engaged with the lock member to the rotating body to be the rotor. Accordingly, the rotor can be locked with a relatively simple structure. Moreover, it is possible to downsize the apparatus.

In one embodiment of the motor lock apparatus according to the present invention, a protection member to cover a part of a surface of the plurality of salient portions contacting with the lock member at the locked position may be arranged at the rotating body to be the rotor. In this case, the salient portions can be protected from the lock member by the protection member.

In one embodiment of the motor lock apparatus according to the present invention, the plurality of salient portions may be projected in the radial direction from the rotating body to be the rotor; the lock member may be inserted between the salient portions of the rotating body to be the rotor in the axis line direction; and the rotating body to be the rotor may include an engagement portion arranged to be rotated integrally with the rotating body to be the rotor having a plurality of protruded portions respectively arranged outside in the axis line direction of the salient portion, the protruded portions having a width in the circumferential direction larger than that of the salient portions while being arranged in the circumferential direction with the same number as the plurality of salient portions at the same intervals as the plurality of salient portions respectively having a space to which the lock member can be inserted. In this embodiment, the lock member can be engaged with protruded portions of which width in the circumferential direction is larger than that of the salient portions when the lock member is moved to the locked position. In this case, since the salient portions can be prevented from being engaged with the lock member, the salient portions can be protected from the lock member.

In one embodiment of the motor lock apparatus according to the present invention, the rotating body to be the stator may be arranged at the outer circumference of the rotating body to be the rotor; the length in the axis line direction of the rotating body to be the rotor may be set to be longer than that of the rotating body to be the stator so that the plurality of salient portions protrude from the rotating body to be the stator; and the lock member may be arranged outside in the radial direction of the protruded portion of the plurality of salient portions from the rotating body to be the stator. It is possible to prevent the motor lock apparatus being elongated in the axis line direction by arranging the lock member at the outside in the radial direction of the rotating body to be the rotor as described above. Accordingly, it is possible to downsize the apparatus further.

There is known a reluctance motor as a motor in which a plurality of salient portions are arranged at a rotating body to be a rotor. The motor may be a reluctance motor in which a plurality of excitation portions are arranged at the rotating body to be the stator in the circumferential direction at equal intervals and the rotating body to be the rotor is rotated by exciting the plurality of excitation portions in predetermined order.

A drive apparatus for a vehicle of the present invention includes an internal combustion engine and a reluctance motor in which a first rotating body to be a rotor and a second rotating body to be a stator arranged at the outer circumference of the first rotating body are arranged to be relatively rotatable about a common axis line and a plurality of salient portions projecting toward the second rotating body are arranged at the first rotating body as being aligned in the circumferential direction, and being capable of driving a drive wheel by utilizing power output from the internal combustion engine and power output from the reluctance motor, and the drive apparatus for a vehicle includes: a motor lock apparatus which includes a lock member fixed to a vehicle body of the vehicle as being non-rotatable about the axis line and being movable between a locked position to be inserted between the salient portions of the first rotating body and an unlocked position to be removed from between the salient portions of the first rotating body, and a drive device to drive the lock member between the locked position and the unlocked position.

According to the drive apparatus for a vehicle of the present invention, similarly to the above motor lock apparatus of the present invention, the first rotating body can be locked by utilizing the plurality of salient portions arranged at the first rotating body. Accordingly, the rotor can be locked with a relatively simple structure. Moreover, it is possible to downsize the apparatus.

In one embodiment of the drive apparatus for a vehicle according to the present invention, a protection member to cover a part of a surface of the plurality of salient portions contacting with the lock member at the locked position may be arranged at the first rotating body. In this case, the salient portions can be protected from the lock member by the protection member.

In one embodiment of the drive apparatus for a vehicle according to the present invention, the lock member may be inserted between the salient portions of the first rotating body in the axis line direction; and the first rotating body may include an engagement portion arranged to be rotated integrally with the first rotating body having a plurality of protruded portions respectively arranged outside in the axis line direction of the salient portions, the protruded portions having a width in the circumferential direction larger than that of the salient portions while being arranged in the circumferential direction with the same number as the plurality of salient portions at the same intervals as the plurality of salient portions respectively having a space to which the lock member can be inserted. In this case, since the lock member and the protruded portions of the engagement portion can be engaged, the salient portions can be prevented from being engaged with the lock member. Accordingly, the salient portions can be protected from the lock member.

In one embodiment of the drive apparatus for a vehicle according to the present invention, the length in the axis line direction of the first rotating body may be set to be longer than that of the second rotating body so that the plurality of salient portions protrude from the second rotating body; and the lock member may be arranged outside in the radial direction of the protruded portion of the plurality of salient portions from the second rotating body. In this case, since the motor lock apparatus can be prevented from being elongated in the axis line direction, the apparatus can be further downsized.

### BRIEF DESCRIPTION OF DRAWINGS

FIG. 1 is a view showing a schematic of a drive apparatus according to a first embodiment of the present invention.

FIG. 2 is an enlarged view of a first motor generator of the drive apparatus of FIG. 1.

FIG. 3 is a sectional view of the first motor generator taken along the line of FIG. 2.

FIG. 4 is an enlarged view of a part of the first motor generator arranged in a first modification of the drive apparatus according to the first embodiment.

FIG. 5 is a view of another example of the first modification.

FIG. 6 is an enlarged view of a part of the first motor generator arranged in a second modification of the drive apparatus according to the first embodiment.

FIG. 7 is a view of another example of the second modification.

FIG. 8 is a view of a first motor generator disposed to a drive apparatus of a second embodiment of the present invention.

FIG. 9 is a view of the first motor generator of FIG. 8 viewing from a direction of arrow IX of FIG. 8.

FIG. 10 is a view showing an example of an in-wheel motor to which a motor lock apparatus of the present invention is applied.

FIG. 11 is a sectional view of a wheel taken along the line XI-XI of FIG. 10.

### DESCRIPTION OF EMBODIMENTS

### First Embodiment

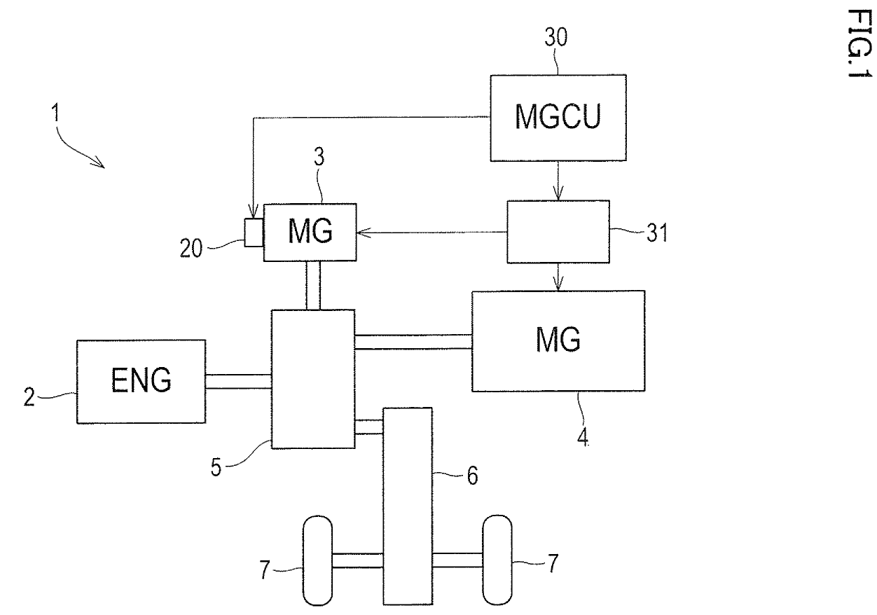

FIG. 1 shows a schematic of a drive apparatus according to a first embodiment of the present invention. The drive apparatus 1 is mounted on a vehicle. As shown in FIG. 1, the drive apparatus 1 is provided with an internal combustion engine 2, and a first motor generator (i.e., a first MG) 3 and a second motor generator (i.e., a second MG) 4 which respectively function as a motor and a generator. The internal combustion engine 2 and the second MG 4 are to be drive power sources of the vehicle. Here, the vehicle is constituted as a hybrid vehicle on which the internal combustion engine 2 and the second MG 4 are mounted as drive power sources. Since the internal combustion engine 2 and the second MG 4 are well-known as engine and motor generator mounted on a hybrid vehicle, thus detailed description thereof will be omitted. A crank shaft 2a of the internal combustion engine 2, an output shaft 3a of the first MG 3 and an output shaft 4a of the second MG 4 are connected to a power split mechanism 5. The power split mechanism 5 is well-known mechanism capable of switching destinations of power output respectively from the internal combustion engine 2, the first MG 3 and the second MG 4 by switching connection states of the internal combustion engine 2, the first MG 3 and the second MG 4. For example, the power split mechanism 5 is constituted with a planetary gear mechanism. The power output from the power split mechanism 5 is transmitted to drive wheels 7 of the vehicle via a speed reducer 6.

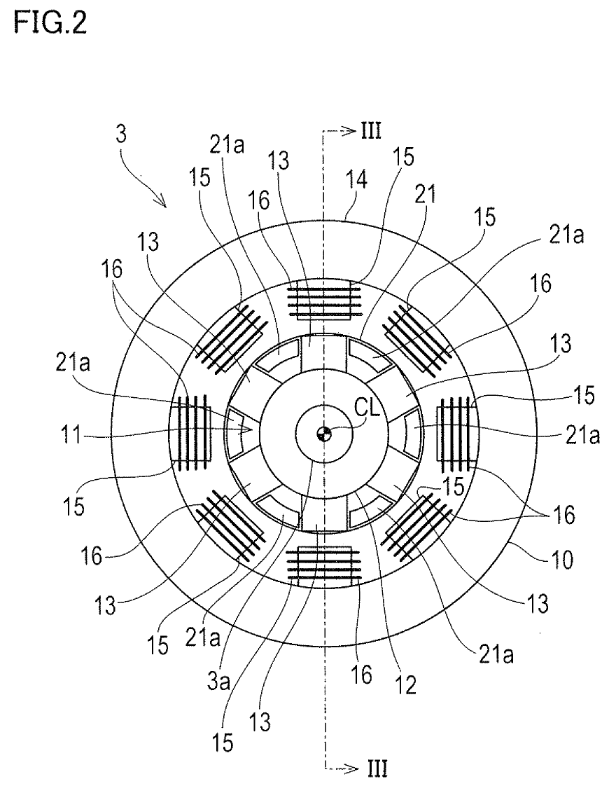

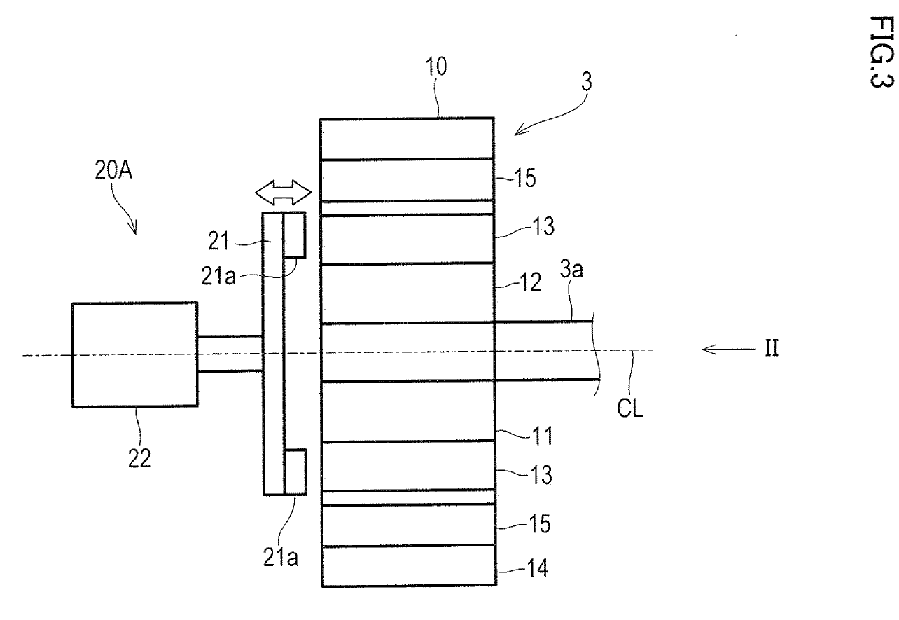

FIGS. 2 and 3 are enlarged views of the first MG 3. FIG. 2 is a view of the first MG 3 viewing from a direction of arrow II in FIG. 3 and FIG. 3 is a sectional view of the first MG 3 taken along the line III-III of FIG. 2. As shown in FIG. 2, the first MG 3 includes a stator 10 and a rotor 11. The stator 10 and the rotor 11 are arranged to be rotatable relatively to each other about a common axis line CL. Further, the stator 10 is placed at the outer circumference of the rotor 11. The output shaft 3a is connected to the rotor 11 so as to be integrally rotated. The rotor 11 includes a cylindrical rotor main body 12 and a plurality of salient rotor poles 13 (e.g., six in FIG. 2) projecting outward in the radial direction from an outer circumferential face 12a of the rotor main body 12. The salient rotor poles 13 are arranged at the outer circumferential face 12a so as to be aligned at equal intervals in the circumferential direction thereof.

The stator 10 includes a cylindrical stator main body 14 and a plurality of salient stator poles 15 (e.g., eight in FIG. 2) projecting inward in the radial direction from an inner circumferential face 14a of the stator main body 14. The salient stator poles 15 are arranged at the inner circumferential face 14a so as to be aligned at equal intervals in the circumferential direction thereof. Here, height of the salient stator poles 15 is set not to cause collision of the salient stator poles 15 with the salient rotor poles 13 when the stator 10 and the rotor 11 are relatively rotated. A coil 16 through which excitation current flow is wound around each salient stator pole 15. Excitation current is supplied to the respective coils 16 sequentially in the circumferential direction, thereby exciting the respective salient stator poles 15 sequentially in the circumferential direction. Then, the salient rotor poles 13 of the rotor 11 are drawn by the excited salient stator poles 15 of the stator 10 sequentially in the circumferential direction, so that the rotor 11 is rotated. That is, the first MG 3 is constituted as a switched reluctance motor. Here, since a method of controlling the excitation current to the respective coils 16 can be the same as a control method generally utilized for a switched reluctance motor, thus detailed description thereof will be omitted. As the first MG 3 is driven as described above, the salient rotor poles 13 of the rotor 11 correspond to salient portions of the present invention and the salient stator poles 15 of the stator 10 correspond to excitation portions of the present invention. Further, the rotor 11 corresponds to a first rotating body and the stator 10 corresponds to a second rotating body.

A motor lock device 20A is disposed at the first MG 3. The motor lock device 20A includes a lock plate 21 as a lock member and an actuator 22 as a drive device to drive the lock plate 21. The lock plate 21 is a circular plate having the same diameter as that of the rotor 11 and is arranged coaxially with the rotor 11 as being opposed to a side face of the rotor 11. A plurality of lock teeth 21a (e.g., six in FIG. 2) arranged at equal intervals in the circumferential direction are provided to the lock plate 21 to be capable of being inserted respectively between the salient rotor poles 13 of the rotor 11 at a predetermined position. Each lock tooth 21a is formed to have a width in the circumferential direction being slightly smaller than the distance between the salient rotor poles 13 of the rotor 11. Then, the lock plate 21 is arranged so as not to be rotatable about the axis line CL and is movable in the axis line CL direction between a locked position at which the lock teeth 21a are inserted respectively between the salient rotor poles 13 of the rotor 11 and an unlocked position at which the lock teeth 21a are removed from between the salient rotor poles 13 of the rotor 11. The actuator 22 drives the lock plate 21 between the locked position and the unlocked position. Here, since the actuator 22 may be a well-known actuator such as an electric actuator or a hydraulic actuator, thus detailed description thereof will be omitted.

Operation of the actuator 22 is controlled by a motor generator control unit (MGCU) 30. The MGCU 30 is constituted as a computer including a microprocessor and peripherals such as RAM and ROM required for the operation. For example, the MGCU 30 switches the operation of the first MG 3 and the second MG 4 to function respectively as a motor or a generator based on drive force required for the vehicle and a charge condition of a battery (not shown) connected to the first MG 3 and the second MG 4. At that time, the MGCU 30 controls the operation of the first MG 3 and the second MG 4 via an invertor 31.

The MGCU 30 controls the actuator 22 to move the lock plate 21 to the locked position when a predetermined lock condition for locking the rotor 11 of the first MG 3 is satisfied. Here, for example, the predetermined lock condition is satisfied in a case that the first MG 3 is not required to be operated as a motor nor a generator. At that time, the MGCU 30 firstly performs position adjustment of the rotor 11. In the position adjustment, the rotor 11 is rotated to a predetermined position at which collision of the respective lock teeth 21a with the respective salient rotor poles 13 of the rotor 11 does not occur when the lock plate 21 is moved to the locked position. Then, after the position adjustment is completed, MGCU 30 controls the actuator 22 so as to move the lock plate 21 to the locked position. Here, for unlocking the rotor 11, the actuator 22 is controlled to move the lock plate 21 to the unlocked position.

The rotor 11 can be locked as engaging the lock teeth 21a and the salient rotor poles 13 by inserting the lock teeth 21a respectively between the salient rotor poles 13 as moving the lock plate 21 to the locked position as described above. On the other hand, the rotor 11 can be unlocked as releasing engagement of the respective lock teeth 21a and the respective salient rotor poles 13 by moving the lock plate 21 to the unlocked position.

As described above, according to the drive apparatus 1 of the first embodiment, the rotor 11 is locked by utilizing the salient rotor poles 13 as inserting the plural lock teeth 21a disposed at the lock plate 21 respectively between the salient rotor poles 13 of the rotor 11. Therefore, it is not required to newly dispose an engagement member to the rotor 11 to be engaged with the lock teeth 21a. Accordingly, the rotor 11 can be locked with a relatively simple structure. Moreover, it is possible to downsize the apparatus.

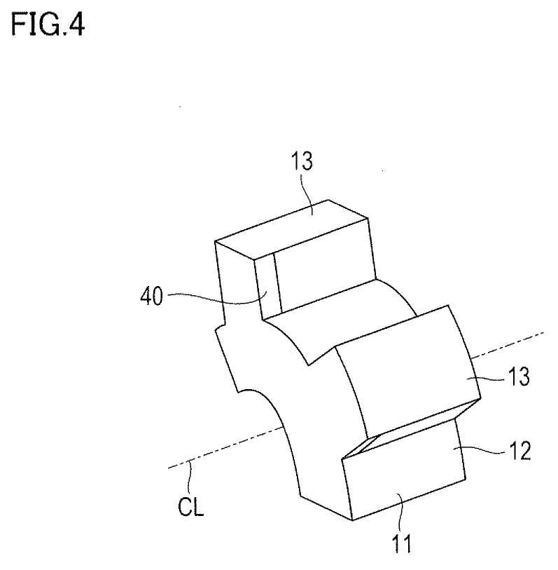

FIGS. 4 to 7 show modifications of the drive apparatus 1 according to the first embodiment. FIG. 4 is a perspective view showing as enlarging a part of the rotor 11 of the first modification. In the first modification, a protection member 40 is arranged at each salient rotor poles 13, as shown in this figure. The rest is the same as the above drive apparatus 1. The protection member 40 is arranged so as to cover apart opposed to each lock tooth 21a at the locked position, that is, a part to be engaged with each lock tooth 21a, in a surface of each salient rotor pole 13. Here, thickness of the protection member 40 is set so that the protection member 40 does not interfere with each lock tooth 21a when the lock teeth 21a are inserted between the salient rotor poles 13. The protection member 40 may be made of elastic material such as rubber, for example, or may be made of metal material. According to the first modification, it is possible to prevent the salient rotor poles 13 from being directly engaged with the lock teeth 21a when the lock plate 21 is moved to the locked position. Accordingly, the salient rotor poles 13 can be protected from the lock teeth 21a.

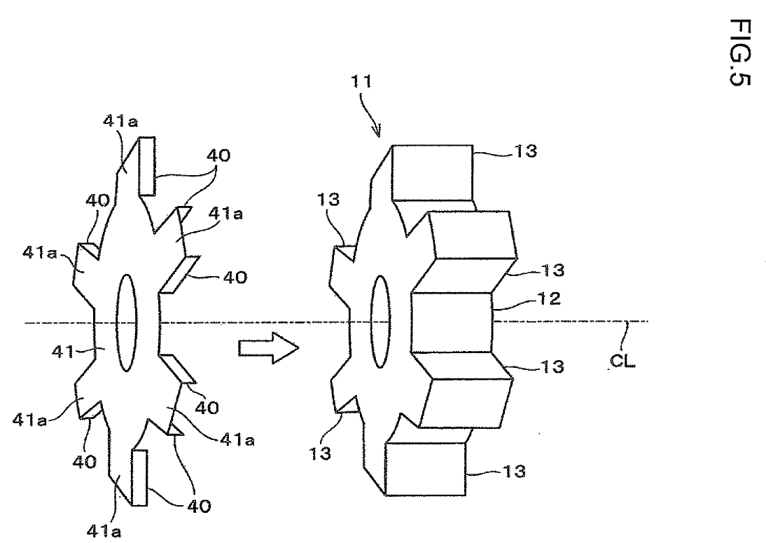

The protection members 40 may be attached respectively to the salient rotor poles 13 separately. Moreover, the protection members 40 may be attached to the salient rotor poles 13 as being integrally formed as a plate member 41 as shown in FIG. 5. The plate member 41 may be formed by cutting a single magnetic steel plate as leaving areas to be the protection members 40 at both sides of a part 41a of the plate member 41 arranged at a side of each salient rotor pole 13, for example, and folding all of the left areas in the same direction as shown in FIG. 5. In this case, the protection members 40 and the plate member 41 are formed of the same material. Labor of an attaching operation of the protection members 40 can be reduced by arranging the protection members 40 integrally with the plate member 41 as described above.

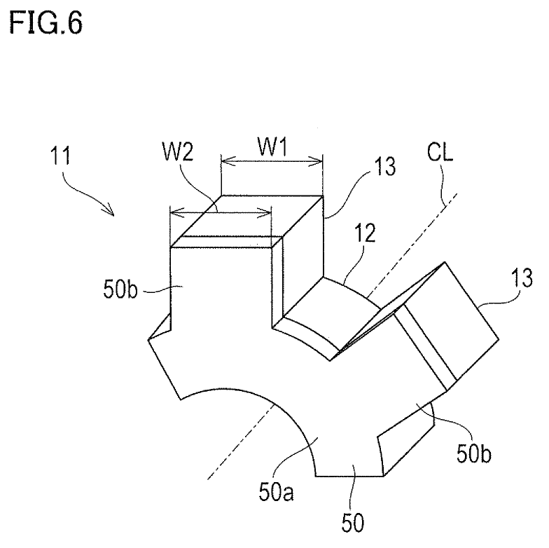

FIG. 6 is a perspective view showing as enlarging a part of the rotor 11 of the second modification. In this modification, the rotor 11 is provided with an end face panel 50 as an engagement portion at a side face of the rotor 11 opposed to the lock plate 21. The end face panel 50 is attached to the rotor 11 so as to be rotated integrally with the rotor 11. The end face panel 50 includes a circular plate portion 50a arranged at a side face of the rotor main body 12 and protruded portions 50b respectively arranged at a side face of each salient rotor pole 13. The circular plate portion 50a is formed in the same shape as a section of the rotor main body 12. Meanwhile, the protruded portions 50b are formed respectively to have a width W2 in the circumferential direction being larger than a width W1 of the salient rotor poles 21a in the circumferential direction and to have spaces between the protruded portions 50b to which the lock teeth 21b can be inserted. Here, height of the protruded portions 50b is the same as height of the salient rotor poles 13. According to the second modification, the rotor 11 can be locked as engaging the lock teeth 21a and the protruded portions 50b of the end face panel 50 when the lock plate 21 is moved to the locked position. In this case, since the salient rotor poles 13 are not engaged with the lock teeth 21a, the salient rotor poles 13 can be protected from the lock teeth 21a.

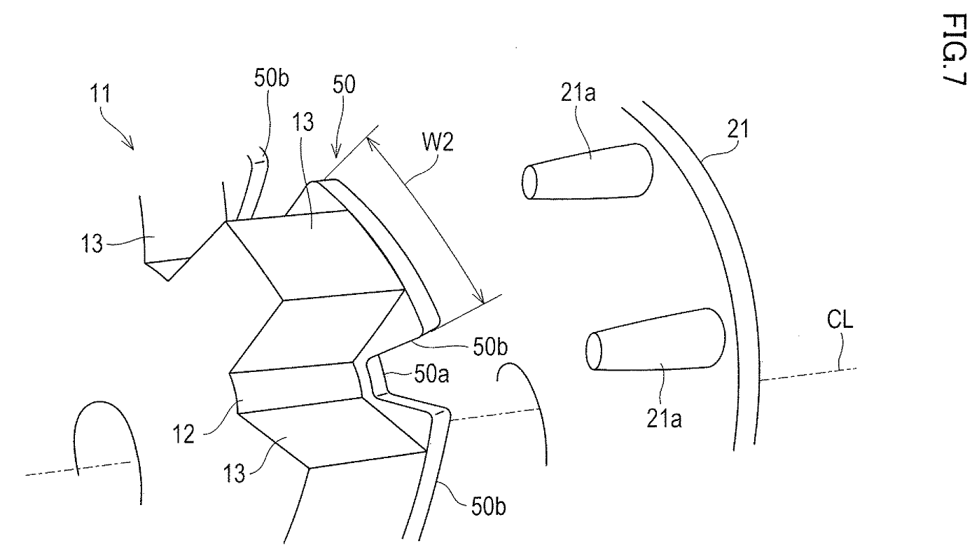

Here, in the second modification, the shapes of the lock teeth 21a and the protruded portions 50b may be appropriately changed. For example, the lock teeth 21a may be formed respectively as a frustum of a cone as shown in FIG. 7. In this case, the protruded portions 50b of the end face panel 50 is formed so as not to generate looseness in the circumferential direction when the lock teeth 21b are inserted respectively between the protruded portions 50b. That is, the width W2 of the protruded portions 50b is set so that the distance between the protruded portions 50b is slightly larger than the diameter of a basal portion of each lock tooth 21b. In this case as well, since the salient rotor poles 13 can be prevented from being engaged with the lock teeth 21a, the salient rotor poles 13 can be protected from the lock teeth 21a.

### Second Embodiment

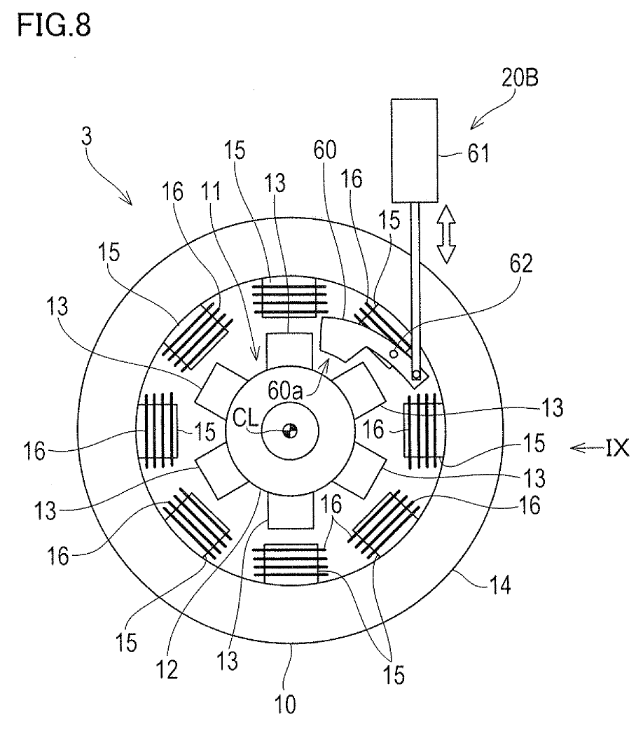

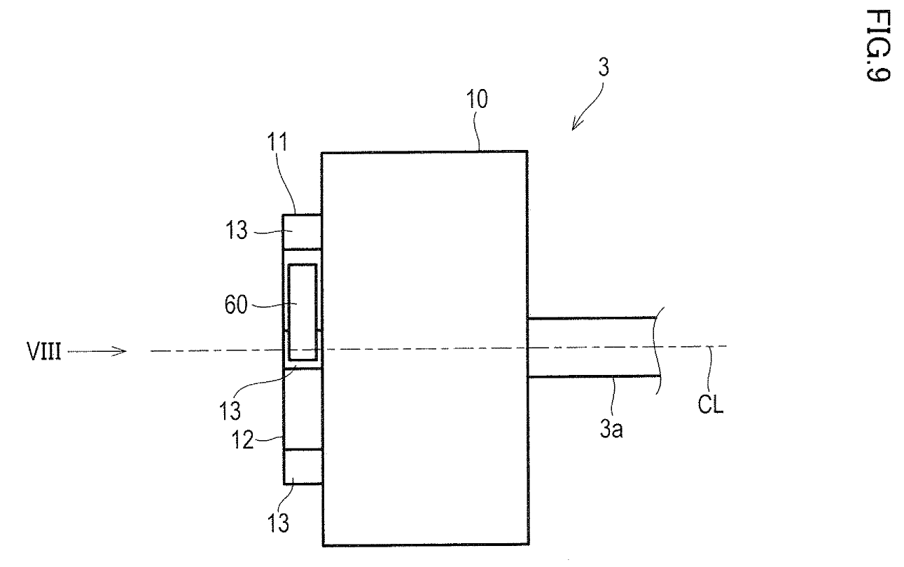

Next, a drive apparatus according to a second embodiment of the present invention will be described with reference to FIGS. 8 and 9. FIGS. 8 and 9 show a first MG 3 provided to the drive apparatus 1 of the second embodiment. FIG. 8 is a view of the first MG 3 viewing from a direction of arrow VIII of FIG. 9 and FIG. 9 is a view of the first MG 3 viewing from a direction of arrow IX of FIG. 8. Since the rest of the second embodiment other than the first MG 3 is the same as the abovementioned first embodiment, thus description thereof will be omitted. Further, in the first MG 3, the common component with that of the first embodiment is designated by the same reference numeral, and description thereof will be omitted.

In the first MG 3 of the second embodiment, the length of the rotor 11 in the direction of the axis line CL is longer than that of the stator 10 so that the salient rotor poles 13 protrude outside the stator 10, as shown in FIG. 9. A motor lock apparatus 208 includes a lock pole 60 as a lock member arranged outside in the radial direction of the protruded portion of the rotor 11 from the stator 10 and an actuator 61 as a drive device to drive the lock pole 60. As shown in FIG. 8, lock teeth 60a to be engaged with the salient rotor poles 13 as being inserted between the salient rotor poles 13 are arranged at one end part of the lock pole 60. As shown in FIG. 8, the lock pole 60 is supported by a pillar 62 so as to be rotatable between a locked position at which the lock teeth 60a are inserted between the salient rotor poles 13 and an unlocked position at which the lock teeth 60a is removed from between the salient rotor poles 13. The actuator 61 drives the lock pole 60 between the locked position and the unlocked position.

According to the motor lock apparatus 208, the lock teeth 60a and the salient rotor poles 13 can be engaged by moving the lock pole 60 to the locked position, so that the rotor 11 can be locked. On the other hand, the engagement is released when the lock pole 60 is moved to the unlocked position, so that the rotor 11 can be unlocked.

In this embodiment as well, since the rotor 11 can be locked by utilizing the salient rotor poles 13 of the rotor 11, the rotor 11 can be locked with a relatively simple structure. Further, in this embodiment, since the lock pole 60 is arranged at the outside in the radial direction of the rotor 11, it is possible to prevent the first MG 3 from being elongated in the axis line direction. Therefore, it is possible to downsize the apparatus. Here, the lock teeth 60a may be formed in any shape as long as being capable of being inserted between the salient rotor poles 13 and being engaged with the salient rotor poles 13. For example, it may be hook-shaped.

The present invention is not limited to the above-described embodiments, and may be embodied in various forms. For example, the motor lock apparatus of the present invention is not limited to the application to the above motor. The present invention may be applied to various types of motors in which a rotor includes a plurality of salient portions projecting in the radial direction as being aligned in the circumferential direction. For example, it is also possible to be applied to a motor in which a plurality of salient portions projecting toward a stator are arranged at the inner circumferential face of a rotor as being aligned in the circumferential direction and the rotor is arranged at the outer circumference of the stator. Further, it is also possible to be applied to a motor in which both of a rotor and a stator are arranged rotatably about an axis line CL. Furthermore, it is also possible to be applied to a motor in which a magnet is disposed at a salient rotor pole.

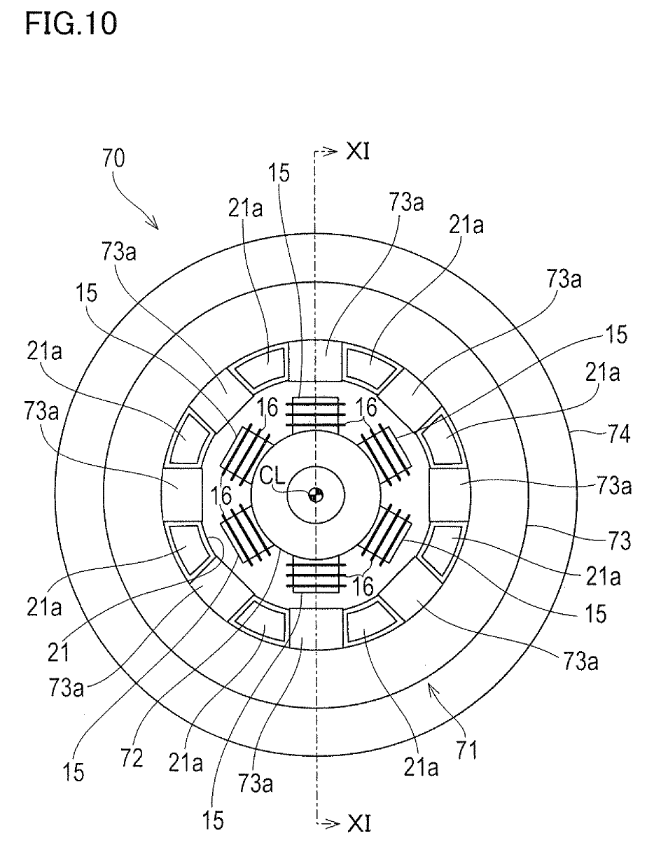

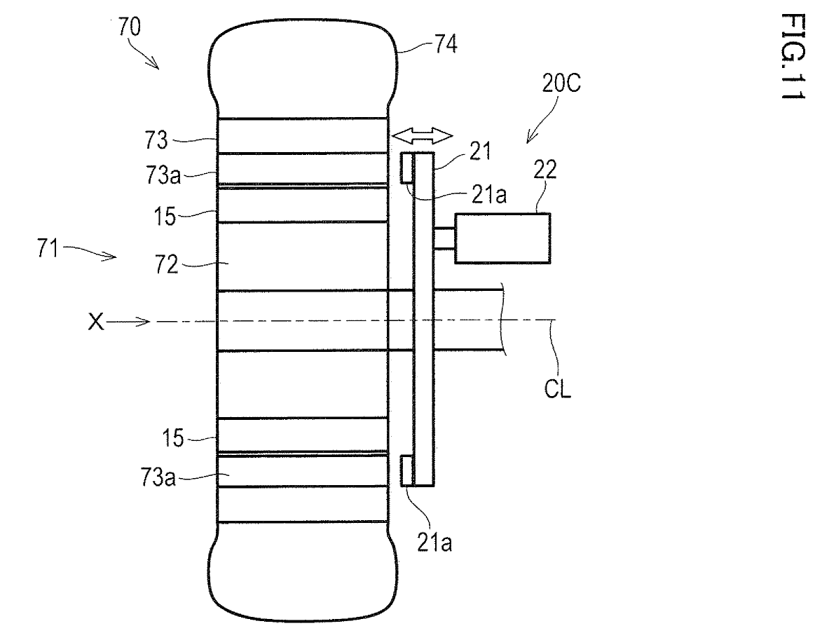

The motor to which the motor lock apparatus of the present invention is applied is not limited to a motor disposed to a drive apparatus for a vehicle. For example, as shown in FIGS. 10 and 11, it is also possible to be applied to a motor 71 which drives a wheel 70 as being disposed in the wheel 70, that is, a so-called in-wheel motor. FIG. 10 is a view of the wheel 70 viewing from the direction of arrow X in FIG. 11 and FIG. 11 is a sectional view of the wheel 70 taken along the line XI-XI of FIG. 10. Here, in FIGS. 10 and 11, the common component with that of the above embodiments is designated by the same reference numeral, and description thereof will be omitted. In the motor 71 as described above, a stator 72 is fixed to a vehicle body and a rotor 73 is coaxially arranged at the outer circumference of the stator 72. Then, a tire 74 is attached to the outer circumference of the rotor 73. When a switched reluctance motor is utilized as the motor 71, a plurality of salient rotor poles 73a projecting toward the stator 72 are arranged at the inner circumferential face of the rotor 73. Then, a motor lock apparatus 20C is arranged such that lock teeth 21a are capable of being inserted between the salient rotor poles 73a as shown in FIG. 11. In this case, a lock plate 21 is placed at a side face of the rotor 73 and the lock plate 21 is arranged to be movable between a position at which the lock teeth 21a are inserted between the salient rotor poles 73a and a position at which the lock teeth 21a are removed from between the salient rotor poles 73a. According to the motor lock apparatus 20C, the lock teeth 21a and the salient rotor poles 73a can be engaged by moving the lock plate 21 to the locked position, so that the rotor 73 can be locked. Therefore, the motor lock apparatus 20C can be utilized to function as a parking brake, for example.

1. A motor lock apparatus applied to a motor which includes a pair of rotating bodies arranged to be relatively rotatable about a common axis line, either one of the pair of rotating bodies functioning as a stator and the other one functioning as a rotor in which a plurality of salient portions projecting toward the rotating body to be the stator are aligned in the circumferential direction, comprising:
a lock member fixed as being non-rotatable about the axis line and being movable between a locked position to be inserted between the salient portions of the rotating body to be the rotor so as to be engaged with the salient portions and an unlocked position to be removed from between the salient portions of the rotating body to be the rotor; and
a drive device to drive the lock member between the locked position and the unlocked position;
wherein a protection member to cover a part of a surface of the plurality of salient portions contacting with the lock member at the locked position is arranged at the rotating body to be the rotor
wherein the salient portions are salient poles of the rotor.

2.-4. (canceled)

5. The motor lock apparatus according to claim 1,
wherein the motor is a reluctance motor in which a plurality of excitation portions are arranged at the rotating body to be the stator in the circumferential direction at equal intervals and the rotating body to be the rotor is rotated by exciting the plurality of excitation portions in predetermined order.

6. A drive apparatus for a vehicle including an internal combustion engine and a reluctance motor in which a first rotating body to be a rotor and a second rotating body to be a stator arranged at the outer circumference of the first rotating body are arranged to be relatively rotatable about a common axis line and a plurality of salient portions projecting toward the second rotating body are arranged at the first rotating body as being aligned in the circumferential direction, and being capable of driving a drive wheel by utilizing power output from the internal combustion engine and power output from the reluctance motor, comprising:
a motor lock apparatus which includes a lock member fixed to a vehicle body of the vehicle as being non-rotatable about the axis line and being movable between a locked position to be inserted between the salient portions of the first rotating body so as to be engaged with the salient portions and an unlocked position to be removed from between the salient portions of the first rotating body, and a drive device to drive the lock member between the locked position and the unlocked position;
wherein a protection member to cover a part of a surface of the plurality of salient portions contacting with the lock member at the locked position is arranged at the first rotating body;
wherein the salient portions are salient poles of the rotor.

7.-9. (canceled)
